(19) United States
(12) Patent Application Publication
(10) Pub. No.: US 2004/0148917 A1
(43) Pub. Date: Aug. 5, 2004

(54) Variable contour mowing machine

(75) Inventor: Michael D. Eastwood, Zionsville, IN (US)

Correspondence Address: NICHOLSON HIRZEL, 113 WHISPER WOOD LANE, BATTLE CREEK, MI, 49015, US

(73) Assignee: Nicholson Hirzel, Battle Creek, MI

(21) Appl. No.: 10/756,008

(22) Filed: Jan. 13, 2004

Related U.S. Application Data
(60) Provisional application No. 60/439,754, filed on Jan. 13, 2003.

(51) Int. Cl. A01D 75/30

(52) U.S. Cl. 56/6

(57) ABSTRACT

A variable contour mowing machine comprising a number of individual rotary mower decks ganged together and the mower decks being driven by electric motors powered from an electric power source, such as an electric generator, associated with the mowing machine. The electric generator is typically driven by the engine that is associated with an attached prime mover.

### CROSS REFERENCE TO RELATED APPLICATIONS

This application is entitled to the benefits of Provisional Patent Application Ser. No. 60/439,754 filed Jan. 13, 2003.

### STATEMENT REGARDING FEDERALLY SPONSORED RESEARCH

Not Applicable

### REFERENCE TO SEQUENCE LISTING

Not Applicable

### BACKGOUND OF THE INVENTION

The present invention relates to gang mower assemblies, and more particularly to terrain following gang mower assemblies comprising a plurality of rotary mower decks supported in such a way to follow very rolling terrain. The present invention relates to the type of gang mower assembly which can be pulled by a conventional tractor and an electric generator being driven from the PTO unit conventionally provided on the tractor transmitting power to electric motors. The assembly comprises a plurality of rotary mower decks arranged such that the rotary decks are spaced apart, along any number of lines perpendicular to the forward direction of travel and sized to provide overlapping cuts as the assembly is moved forward.

In the preferred embodiment of the present invention, each of the mower decks is provided with a rotary cutting blade which rotates about a centrally disposed, upwardly extending axis. An electric motor is coupled directly to the axis for driving the blades. In this preferred system, when the mower decks contour flex relative to each other and the tractor moves over rather steep rolling land or steep, but small hills and valleys, such as those commonly found on a golf course rough, the mower decks are fully independent.

This invention is concerned with improvements in or relating to gang mowers. Gang mowers comprise a plurality of individual mowing units which are linked together and which are propelled together, the arrangement of the gang being such that a much wider swath of grass can be cut in a single pass than is possible with a single mower unit. Rotary gang mowers are commonly used to cut the rough grass on golf courses, but, of course can be, and are used in other applications such as commercial properties and municipal fields.

Prior art efforts that have embodied gang reel mowers that are electric motor driven and contour flex relative to each other to follow the terrain are;

a) an alternating current generator driven from an agricultural tractor pulling a gang of reel mowers. Each reel mower is driven by an electric motor. This is suitable for maintaining shorter grass, e.g. golf course fairways but is not as well suited for longer grass, e.g. golf course rough, commercial properties and municipal fields.

Prior art efforts that have embodied gang mower decks that can contour flex relative to each other to follow the terrain are;

a) providing gang mower assemblies that are self propelled. These types power the cutters by electric motor, hydraulic, belt and direct shaft. These efforts are expensive to purchase, complicated and difficult and expensive to maintain. These efforts are concentrated to the greens area of a golf course.

Prior art efforts that have embodied gang mower decks that can contour flex relative to each other to follow the terrain are;

a) providing gasoline engines on a plurality of rotary mower decks. Each engine is directly coupled to an individual deck. This effort has low efficiency, high maintenance and is environmentally unfriendly;

b) providing hydraulic motors on a plurality of mower decks with a plurality of hydraulic hoses connecting each hydraulic motor to a central hydraulic pump. The tractor provides the power to create hydraulic pressure. This effort tends to leak oil into the environment and is inefficient;

c) direct coupling of the PTO drive on the tractor to a plurality of mower decks by using a separately movable drive shaft coupled to each deck. This effort has limited independent contour capabilities and is difficult to maintain; and

d) providing a plurality of mower decks with a plurality of V-belts connecting each deck, being all connected together and providing driving power from the tractor PTO. This effort is inefficient and has limited contour capabilities.

It is the object of the invention to provide a rotary gang mower wherein the rotary mower deck of each mower unit is driven by an electric motor. The advantages of a hybrid electric generator and electric motor system are many and well known. They are low operating cost, high efficiency, environmentally friendly and easy for mechanics to repair and replace. The problem with the prior art is that it does not wholly embody all of these attributes with fully independent contour capabilities.

What is new is this invention's ability to utilize electrical energy, generated mechanically, to mow a greater variety of ground contours and conditions with a reduction in maintenance and increased reliability. Current mowing machines that utilize individual rotary mowing decks for wide applications cannot handle a large variety of rolling contours in the grass surface. Maintenance will be greatly reduced by elimination of mechanical drives and/or hydraulic drives. Reliability will increase by the increase mean time between failures of electrical components versus mechanical components.

### BRIEF DESCRIPTION OF THE SEVERAL VIEWS OF THE DRAWING

FIG. 1: The preferred design of the variable contour mowing machine.

FIG. 2: Side detail of a preferred individual mower deck.

FIG. 3a: Mower decks from the rear shown on a level surface.

FIG. 3b: Mower decks from the rear shown on a typical contour surface.

FIG. 4: Detail of the electric motor mounting onto the mower deck.

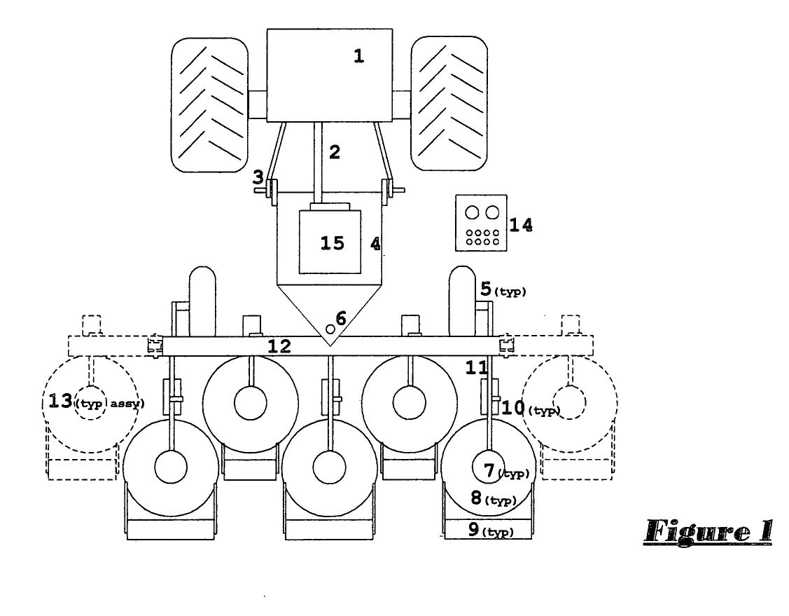

FIG. 1a: Additional concept of a variable contour mowing machine design.

FIG. 1b: Additional concept of a variable contour mowing machine design.

FIG. 1c: Additional concept of a variable contour mowing machine design.

### DETAILED DESCRIPTION OF THE INVENTION

Referring to FIG. 1 and within the preferred design, the prime mover (1) for the contour mowing machine is a landscaping or agricultural type tractor that has a power take off (2) and is rated between 20-40 Hp.

Also, the prime mover can be any self-propelled piece of equipment that is able to move the mower.

Also, the prime mover does not have to power the mower.

Also, the prime mover does not require the ability to lift the mower.

Also, any sort of propulsion system including but not limited to internal combustion, solar, stored electric, hybrid electric can propel the prime mover.

Also, the prime mover can be any Hp (Kw) rating to supply enough power to move the mower along any type of turf grass surface.

Referring to FIG. 1 and within the preferred design, the main frame (12) is made of steel and designed to pull and lift the sub frame (11). The main frame (12) rides on larger wheels (5) attached directly to the main frame (12) allowing for raising and lowering the mower decks (8) for transport and maintenance. The generator main frame (4) helps to support the main frame (12) and is coupled via a hitch (6). The generator frame (4) pulls the main frame (12) which in turn pulls the sub frame (11) horizontally. The hitch (6) from the generator frame (4) to the main frame (12) is able to pull and rotate freely through a ball and socket arrangement. The generator frame (4) is supported by the prime mover's 3-point hitch (3). The contour flex design is to support the mower decks (8), following the contour of the ground and minimize compaction are semi soft tires (9) and rollers (10). The generator frame (4) is designed to support the weight of the generator set (15) and a portion of the main frame (12). The entire unit is designed to be pulled.

Also, the mainframe and sub frame can be built of any sturdy, rigid material able to withstand vibrations and the weight of the components.

Also, the frames can be integrated into one or any number of frames.

Also, the frames can be supported by the ground or supported entirely by the prime mover.

Also, the frame can be pulled or pushed.

Also, the mower decks can be pulled or pushed by the mainframe or any sub frame.

Also, the support from the ground can be by any type of tire or system that can support the frame or sub frame.

Also, the support from the prime mover can be any type of attachment including but not limited to a 3-point hitch.

Also, the sub frame can be attached to the main frame with any type of hitch including but not limited to a ball and socket trailer type hitch.

Also, the generating unit is not limited to having the frame as its support.

Also, the entire unit can be front mounted, belly mounted, side mounted, rear mounted or any combination of these positions to the prime mover.

Referring to FIG. 1 and within the preferred design, the direct current (DC) generator (15) is driven from the power take off (2) of the prime mover (1). The DC generator (15) provides electric power capable of operating the individual electric DC motors (7) powering the mowing decks (8) and electric control panel (14). This DC generator (15) is the source of converting mechanical energy from the prime mover (1) into electrical energy to be used by the invention.

Also, it is possible with this invention to mount an alternate power source, such as an IC engine, which has as its purpose the driving of the electric generator, allowing for the disassociation with the prime mover as the generating power source.

Also, any number of generating units can be used in combination or as individual discrete units.

Also, it is possible to power the electrical motors powering the mowing decks directly with fuel cells or other alternative electric sources in lieu of or in conjunction with the generating unit.

Also, the electric specifications of the electric power source can be any Hz and any voltage, alternating or direct current that is capable to power the invention.

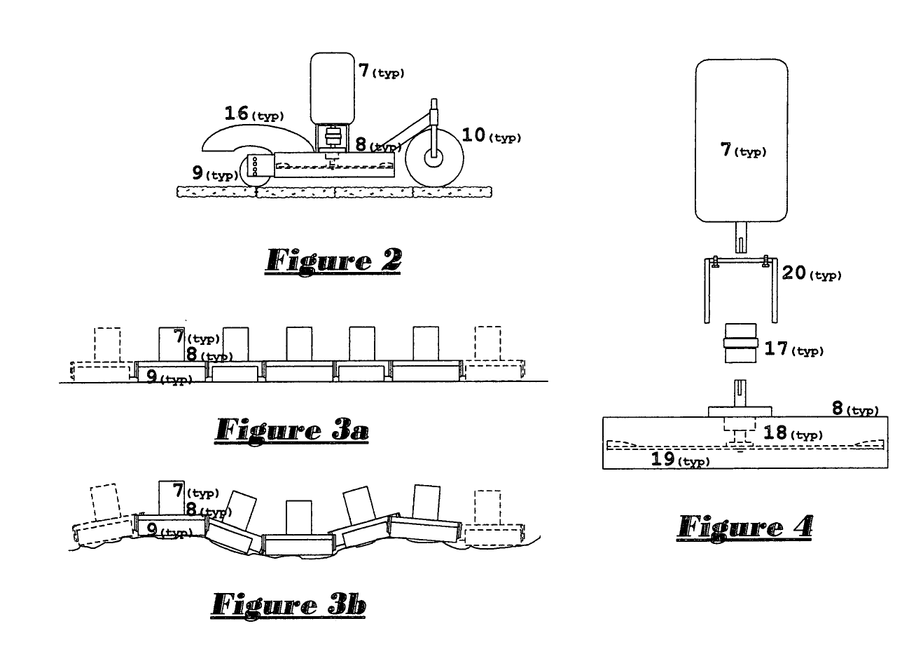

Referring to FIG. 2 and within the preferred design, each individual mower deck (8) will be supported by the ground surface allowing for float of the individual mower decks (8) Front height control will be accomplished utilizing small floatation tires (10) to follow the ground contour. These tires (10) will have individual adjustment. Rear height control will be accomplished utilizing long rollers (9) to follow the ground contour, with individual adjustment. The rollers (9) in the rear position are also utilized to provide cut texturing of the grass surface. The deck will have top to rear discharge (16) to facilitate texturing and safety.

Also, the adjustment of the mower deck height can be accomplished in any variety of ways that allow for the following of the ground contour.

Also, the contact with the ground is not limited to wheels or rollers, but includes any type of support from the turf grass surface.

Also, the height adjustment can be accomplished though digital sensors with electric and/or hydraulic means of control.

Also, the height control is not limited to the front and rear but can be from any part of the mower deck, frame or cutting device.

Also, the height control can be dependent or independent of the sub frame or frame.

Also, the height can be adjusted through any combination of individual or group controls by means of pulleys, gears, hydraulics or electrical devices that can couple the height adjustments together.

Also, the motors and or cutters can be driven in a clockwise or counterclockwise rotation allowing for variety of texturing of the grass surface.

Also, the discharge from the mower deck can be from any opening on the mower deck and can be discharged in any direction, or have no discharge at all.

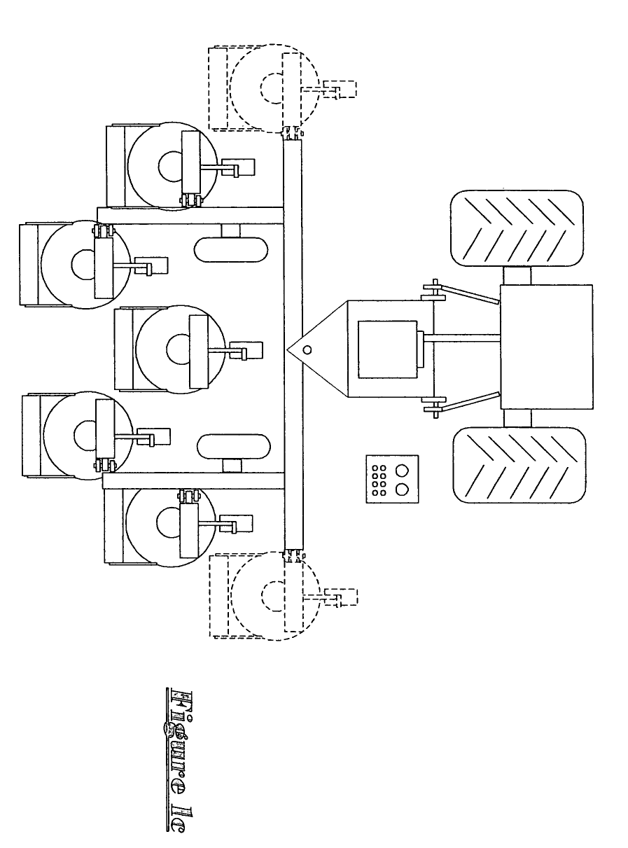

Referring to FIG. 4 and within the preferred design, conventional rotary mower blades (19) on the mower decks (8) are driven by single dedicated electric DC motors (7). Each individual mower assembly consists of a C-face flange electric DC motor (7), C-flange pedestal (20) mounted to the mower deck (8), contour flexible transmission coupling (17), spindle (18) and blade (19).

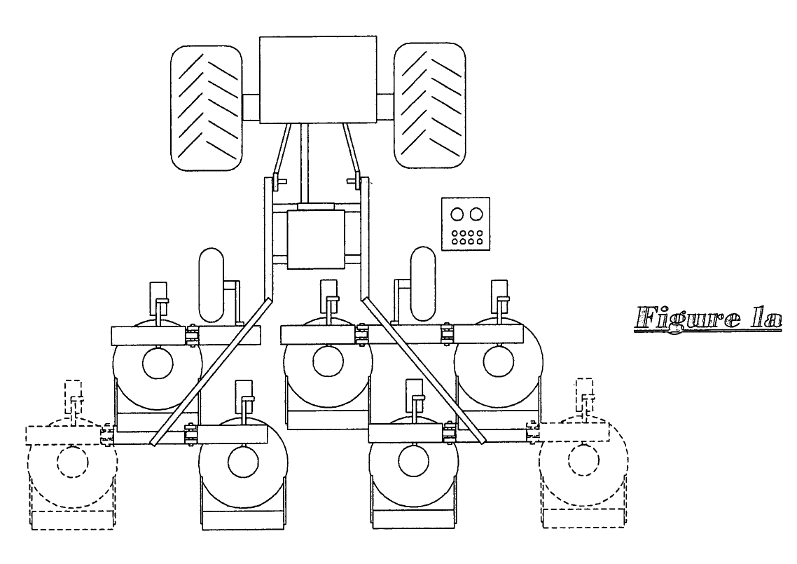

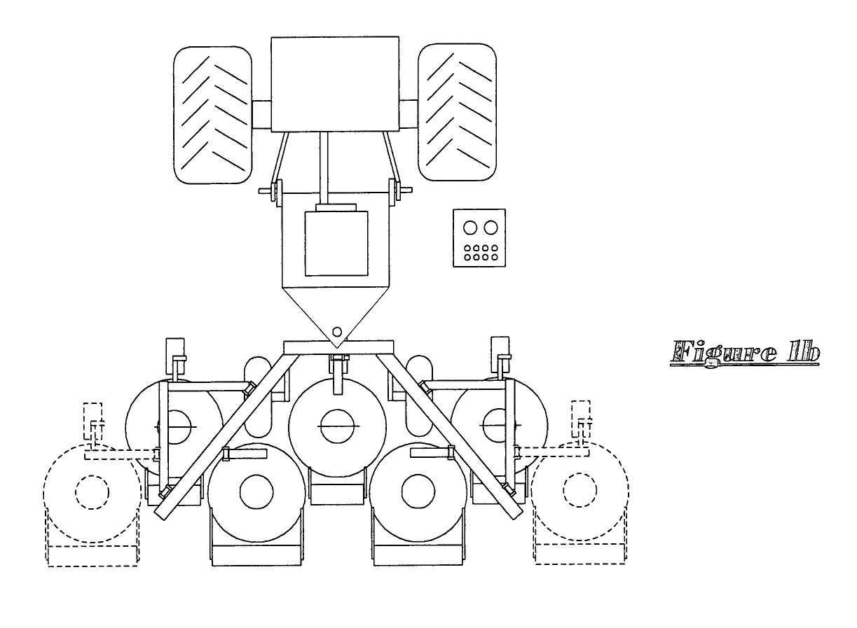

Referring to FIG. 3a and within the preferred design, the mowers decks are arranged in a gang such that they provide overlapping mowing of the grass surface.

Referring to FIG. 3b and within the preferred design, illustrates the complex type of contour surface that the invention is intended to manage.

Also, the number of decks can vary from two to any number.

Also, the decks can be arranged in any fashion.

Also, the decks can be supported in any fashion, not limited to a frame during transport.

Also, the decks can be supported in any fashion, not limited to the ground and frame during operation.

Also, the cutting devices can be but are not limited to lawn mower type, flail type, saw type, string type or centrifugal swing type blades.

Also, the decks can have one or any number of cutting devices per deck.

Also, the electric drive motor can operate one to any number of decks.

Also, the electric drive motor can operate one to any number of cutting devices.

Also, the mower decks and cutting devices may have any or all options including rear rollers, mulching blades, mulching discharge, bagging, plugging, thatching, etc. that are common to the turf grass industry.

Referring to FIG. 1 and within the preferred design, this remote panel (14) will be located near the operator position for ease of interface. The control panel (14) will control on/off operation of the individual motors, operator feed back of operation (lights, gauges, etc.), emergency safety shutoff devices, raising/lowering of end units (for width variation) and raising/lowering of all decks (for transportation).

Also, the control panel can located anywhere on the invention.

Also, the control panel and control system can be controlled through a programmable logic controller.

Also, the control panel function includes but is not limited to electrical functions, hydraulic functions and mechanical functions.

Also, the control panel can provide feedback from any system associated with the mower, prime mover, generating device and frame and can provide operator input to monitor or adjust these systems.

Also, the electric controls can be powered from the generating unit or the prime mover or another electric source or in any combination of sources.

Referring to FIGS. 1a, 1b, 1c, these figures illustrate the variety of designs that are able to utilize this invention. These are typical frame designs currently found in the agricultural and turf grass industries that can utilize the benefits of this invention. FIGS. 1, 1a, 1b, and 1c also illustrate the ability to add additional mower decks (13, FIG. 1) to increase the width of cut. The generator and prime mover must be increased in size accordingly. It is envisioned that the invention will be wholly electric, however, it is also recognized that hydraulic lift cylinders may be employed in place of electric lift actuators.

### SUMMARY OF THE INVENTION

In according of the embodiments of the claims, this variable contour mowing machine is comprised of a multiplicity of mower decks. The mower decks are powered by electric motors. The electric motors receive power from a generator or a stored energy power source. The power source for the electric generator is not attached to the variable contour mowing machine. The variable contour mowing machine is not self propelled and relies on an attached prime mover for propulsion.

What I claim is:

1. A variable contour mowing machine comprising;
(a) multiplicity of rotary cutting decks;
(b) said decks are powered by electric motors,
(c) said electric motors are powered by a stored energy power source;
(d) is not self propelled.

2. The variable contour mowing machine of claim 1, wherein the rotary cutting decks are comprised of a rotary cutting blade which rotates about a centrally-disposed, upwardly-extending axis.

3. The variable contour mowing machine of claim 1, wherein the rotary cutting decks are comprised of two or more individual decks.

4. The variable contour mowing machine of claim 1, wherein the electric motors are coupled to one or more said rotary cutting decks.

5. The variable contour mowing machine of claim 1, wherein the electric motors are direct current (DC).

6. The variable contour mowing machine of claim 1, wherein the electric motors are alternating current (AC).

7. The variable contour mowing machine of claim 1, wherein the rotary cutting decks are supported by rolling supports that follow the ground contour.

8. The variable contour mowing machine of claim 1, wherein the power source is a fuel cell.

9. The variable contour mowing machine of claim 1, wherein the power source is a battery.

10. The variable contour mowing machine of claim 1, wherein the power source is a super capacitor.

11. A variable contour mowing machine comprising;
(a) multiplicity of rotary cutting decks;
(b) said decks are powered by electric motors,
(c) said electric motors are powered by a generator,
(d) is not self propelled.

12. The variable contour mowing machine of claim 11, wherein the rotary cutting decks are comprised of a rotary cutting blade which rotates about a centrally-disposed, upwardly-extending axis.

13. The variable contour mowing machine of claim 11, wherein the rotary cutting decks are comprised of two or more individual decks.

14. The variable contour mowing machine of claim 11, wherein the electric motors are coupled to one or more said rotary cutting decks.

15. The variable contour mowing machine of claim 11, wherein the electric motors are direct current (DC).

16. The variable contour mowing machine of claim 11, wherein the electric motors are alternating current (AC).

17. The variable contour mowing machine of claim 11, wherein the rotary cutting decks are supported by rolling supports that follow the ground contour.

18. The variable contour mowing machine of claim 11, wherein the electric generator is powered by an internal combustion engine that is not attached to the mowing machine.

19. The variable contour mowing machine of claim 11, wherein the electric generator is powered by a turbine that is not attached to the mowing machine.

20. The variable contour mowing machine of claim 11, wherein the electric generator is powered by a hydraulic motor that is not attached to the mowing machine.
